(19) United States
(12) Patent Application Publication
(10) Pub. No.: US 2024/0093804 A1
(43) Pub. Date: Mar. 21, 2024

(54) MEMS FOR CONTROLLING A FLUID FLOW

(71) Applicant: Fraunhofer-Gesellschaft zur Förderung der angewandten Forschung e.V., München (DE)

(72) Inventors: Anton MELNIKOV, Dresden (DE); Bert KAISER, Dresden (DE)

(21) Appl. No.: 18/525,265

(22) Filed: Nov. 30, 2023

Related U.S. Application Data
(63) Continuation of application No. PCT/EP2021/064987, filed on Jun. 4, 2021.

(51) Int. Cl. F16K 99/00

(52) U.S. Cl. CPC F16K 99/0011; F16K 99/0042; F16K 2099/008

(57) ABSTRACT

An MMS has a first layer which has a first opening for letting pass a fluid. Additionally, a second layer which is arranged opposite the first layer is provided, and having a second layer for letting pass the fluid. Together with the first layer, it forms at least part of a layer stack with layers stacked in a stacking direction perpendicular to a substrate plane of the MEMS. A cavity arranged between the first layer and the second layer is arranged and has an element which is moveable along a direction in parallel to the substrate plane, which has at least a first and a second positioning, wherein, in the first positioning, flow-through of the fluid is inhibited and, in the second positioning, flow-through of the fluid through the cavity along the stacking direction is possible.

### CROSS-REFERENCE TO RELATED APPLICATION

This application is a continuation of copending International Application No. PCT/EP2021/064987, filed Jun. 4, 2021, which is incorporated herein by reference in its entirety.

### TECHNICAL FIELD

The present invention relates to an MEMS for inhibiting or allowing flow-through of a fluid through openings of the MEMS. The present invention relates in particular to an over protection device or overpressure valve in MEMS devices.

### BACKGROUND OF THE INVENTION

Overpressures may form in different devices in different situations and may result in material stress or even damage for the concerned device.

Solutions as protection devices for overpressure are sufficiently known from the conventional technology. However, what is less known are technologies which are based on the MEMS technologies mentioned above. Document US 2015/041931, for example, suggests a membrane-based protection device. In an open position, a membrane allows sound energy to pass through from the outside of the apparatus to the inside of the apparatus. In a closed position, the membrane touches an outer face of the opening so as to block, at least partly, sound energy from passing through from the outside of the apparatus to the inside of the apparatus.

Document U.S. Pat. No. 6,590,267 suggests a device which is based on an actively deflectable actuator principle. The MEMS valve device disclosed is based on a membrane which can be actuated by actively deflectable electrode elements, and bias elements. The membrane covers an opening and can easily be moved relative to the same by the electrode elements.

A comparatively complex design is a disadvantage of the solutions known.

Consequently, there is demand for simple and space-saving ways of reducing overpressure.

An object underlying the present invention is providing an MEMS which allows providing for flow-through of a fluid in a simple and space-saving setup, allowing to correspondingly handle pressures of a fluid.

### SUMMARY

According to an embodiment, an MMS may have: a first layer having a first opening for letting pass a fluid; a second layer arranged opposite the first layer and having a second opening for letting pass the fluid and forming, together with the first layer, at least a part of a layer stack having layers stacked in a stacking direction which is perpendicular to a substrate plane of the MMS; a cavity arranged between the first layer and the second layer; an element arranged in the cavity and moveable along a direction in parallel to the substrate plane, which alternatingly has at least a first positioning and a second positioning, wherein, in the first positioning, flow-through of the fluid is inhibited; and, in the second positioning, flow-through of the fluid through the cavity along the stacking direction is allowed.

Another embodiment may have a system having an inventive MMS as mentioned above.

A core idea of the present invention is having recognized that a lateral in-plane movement of a moveable element is able to inhibit flow-through of a fluid and that flow-through can be allowed at a different positioning of the same element. In-plane movement allows obtaining a simple mechanical structure which additionally can be realized in a space-saving manner.

In accordance with an embodiment, an MMS comprises a first layer comprising a first opening for letting pass a fluid. The MMS comprises a second layer which is arranged opposite the first layer and comprises a second opening for letting pass the fluid. The second layer, together with the first layer, forms at least part of a layer stack of the MMS, comprising a stacking direction which is perpendicular to the substrate plane of the MMS, along which the layers of the layer stack are stacked. The MMS comprises a cavity arranged between the first layer and the second layer. A moveable element is arranged in the cavity, which is moveable along a direction in parallel to the substrate plane, comprising a first and second positioning. In the first positioning, flow-through of the fluid is inhibited and, in the second positioning, flow-through of the fluid through the cavity along the stacking direction is possible.

### BRIEF DESCRIPTION OF THE DRAWINGS

Embodiments of the present invention will be discussed below in greater detail referring to the appended drawings, in which:

FIG. 1 shows a schematic perspective view of an MMS in accordance with an embodiment;

FIG. 2a is a schematic top view of a part of an MMS in accordance with another embodiment, in which a movable element is connected to a side wall of the MMS on both sides via connecting elements;

FIG. 2b is an illustration, comparable to FIG. 2a, in which there is a fluidic pressure within an MMS cavity;

FIG. 2c is an illustration, comparable to FIG. 2b, in which the valve is open;

FIGS. 3a-c are schematic top views, comparable to FIGS. 2a-c, of an MMS in accordance with an embodiment in which the movable element is suspended or fixed at beam ends and by means of mounting regions;

FIG. 3d shows a schematic view of a state of the MMS of FIG. 3a in which the moveable element is arranged in a first positioning;

FIG. 3e shows a schematic side sectional view of the MMS of FIG. 3d in which the movable element is arranged in a second state;

FIG. 4 shows a schematic illustration of a part of an MMS of FIG. 2a for explaining specific dimensions in accordance with embodiments;

FIG. 5a shows a schematic function having displacement of a moveable element of an embodiment relative to a level of the pressure applied;

FIG. 5b shows schematic illustrations of graphs for discussing that, by means of the implementation of the pressure occurring in the cavity as illustrated in FIG. 5a, the pressure level can always be kept such that potential damage of a structure is avoided;

FIGS. 6a-6g are schematic top views of possible implementations of an MMS or the movable element in accordance with embodiments;

FIG. 7a shows a schematic block circuit diagram of a system in accordance with an embodiment, having a unidirectional valve; and

FIG. 7b shows a schematic block circuit diagram of a system in accordance with an embodiment, having a bidirectional overpressure valve function.

### DETAILED DESCRIPTION OF THE INVENTION

Before discussing in greater detail embodiments of the present invention referring to the drawings, it is to be pointed out that identical elements, objects and/or structures or those of equal function or equal effect are provided with equal reference numbers in the different figures so that the description of these elements illustrated in different embodiments is mutually exchangeable or mutually applicable.

Embodiments described below will be described in the context of a plurality of details. However, embodiments may also be implemented without these detailed features. Furthermore, for reasons of understandability, embodiments will be described using block circuit diagrams as a substitute for a detailed description. Additionally, details and/or features of individual embodiments may easily be combined with one another, unless the opposite is described explicitly.

Embodiments described below relate to micro-electromechanical structures (MEMS). MEMS may be manufactured using semiconductor materials, like silicon materials, wherein alternatively or additionally other materials, like metal materials or the like, may also be used.

Embodiments described herein relate in particular to micro-mechanical structures (MMS) of which MEMS really form a sub-group since MEMS describe micro-electromechanical systems.

As will be discussed below in greater detail, similar embodiments may comprise sensor characteristics and/or actuator characteristics, which may render an MMS to form an MEMS. However, other aspects of embodiments described herein are not restricted to such sensor and/or actuator characteristics. Consequently, such embodiments which are described herein as MEMS are not necessarily configured for using and/or generating an electrical signal. Rather, the terms “MMS” and “MEMS” are used as synonyms in the context of the embodiments described herein.

It has been recognized by the inventors that the publications mentioned above show solutions which are disadvantageously restricted to realizing movement of a membrane out of the layer plane of an MEMS layer stack. In addition, the membrane and the corresponding surface, on which the membrane rests for sealing purposes, is matched to each other to obtain a sufficiently high sealing effect. In other words, a device is used, in which only very small masses have to be moved over a very short path for opening and closing. It is of disadvantage, that no features can be gathered from these documents as to how a passive overpressure protection device for MEMS could be implemented.

This out-of-plane movement, however, entails a complex structure of a corresponding valve in order to reliably interrupt the fluid flow.

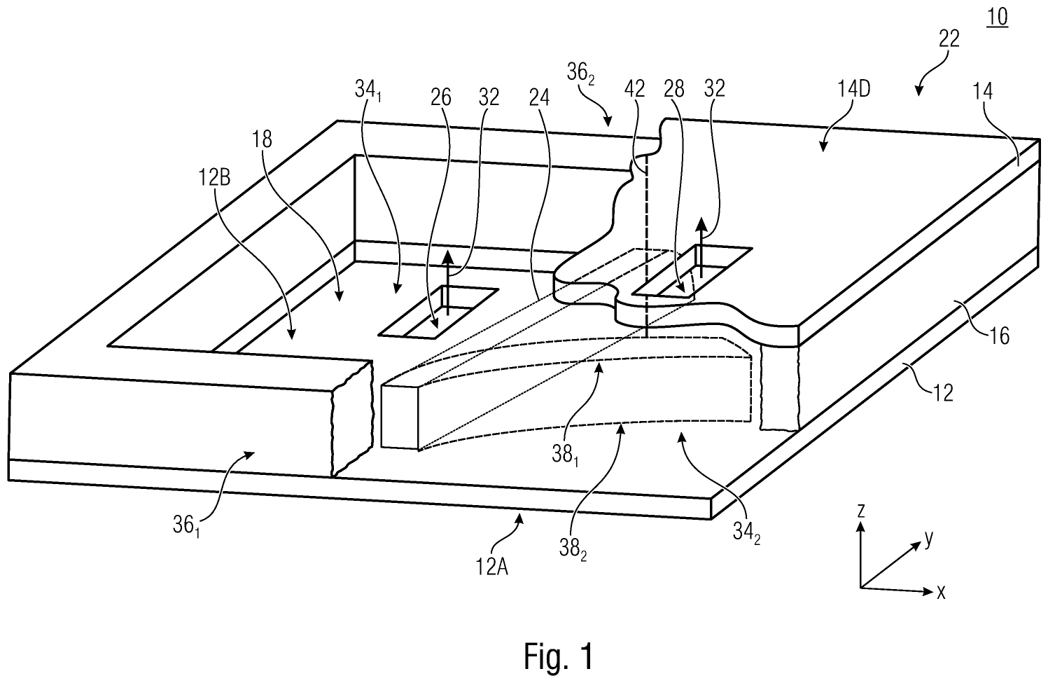

FIG. 1 shows a schematic perspective view of an MMS 10 in accordance with an embodiment. The MMS 10 comprises a first layer 12 and a second layer 14 which may be formed, for example, comprising a material compatible with MMS/MEMS processes, for example a semiconductor material. For an improved graphical illustration, both layer 14 and layer 16 are illustrated only partly.

Optionally, the layers 12 and/or 14 may comprise, partly or completely, other materials, like metal materials or the like, and/or may be formed to be electrically conductive at least in regions, based on doping. Alternatively or additionally, electrically insulating materials, like oxide materials or nitride materials, for example, may also be arranged. An optional third layer 16 is arranged between the first layer 12 and the second layer 14, whose characteristic of confining a cavity 18 between the first layer 12 and the second layer 14 may also be implemented in different ways, for example by introducing trenches or recesses into the first layer 12 and/or the second layer 14 to nevertheless obtain the cavity 18 when directly merging the layers 12 and 14.

The layers 12 and 14 form at least part of a layer stack 22 which in the present case also comprises the layer 16. The layer 16, if present, may also be formed from MMS/MEMS-compatible materials, like the layers 12 and/or 14.

A moveable element 24 is arranged in the cavity 18. The movable element 24 may, for example, be formed by selectively removing material of the layer 16 from the layer 16. Alternatively, it is also possible to introduce the moveable element 24 into the cavity 18 and/or transport and fix it there. In embodiments, the moveable element 24 is a bending beam or deformable element which is arranged to be suspended on one side or two sides and is not suspended, at least partly, but advantageously relative to the layers 12 and 14. For example, the moveable element 24 may be dissolved from the layer 16, for example by means of selective etching processes.

The layer stack 22 may thus comprise at least two layers, but also more layers, in particular since further layers may be arranged also to the layers 12, 14 and, optionally, 16. The layers 12, 14 and/or 16 can be mechanically fixedly connected to neighboring layers, for example by means of a bonding process. Even if no new layers are formed here in the sense of a layer stack, nevertheless materials can be generated for the interface between the two layers.

The layer 12 comprises an opening 26. Although the opening 26 is illustrated as a single opening connecting two opposite main sides 12A and 12B of the layer 12, the opening 26 may also be implemented by two or more sub-openings.

Also, the layer 14 comprises an opening 28 which connects a first main side, not illustrated here, and an oppositely arranged main side 14B of the layer 14. A fluid 32, that is a liquid and/or gas, can flow through the opening 26. The fluid 32 may also flow through the opening 28. This means that a flow through a fluidic path can be generated between the openings 26 and 28.

In the positioning of the moveable element 24 illustrated in FIG. 1 by continuous lines, however, the movable element 24 blocks the flow-through of the fluid 32 from the opening 26 towards the opening 28. This means that the flow-through of the fluid 32 is inhibited by the cavity 18, in particular to flow from the opening 26 towards the opening 28, or vice versa. Thus, the moveable element 24 extends in the cavity such that an acoustic or fluidic short-circuiting is inhibited between sub-cavities 34₁ and 34₂ which form on opposite sides of the movable 24 in the cavity 18. This means that the moveable element 24 may have a small or no distance at all to side walls 36₁ and/or 36₂ relative to which the moveable element 24 is arranged to be adjacent, or arranged thereon. The side walls 36₁ and/or 36₂ here do not have to be arranged to be opposite each other and may, in accordance with embodiments, also be implemented by a single side wall, as will be described in the context of embodiments.

Additionally, a distance between the moveable element 24 and the layer 12 and the layer 14 can be kept small to keep fluidic losses by the flow through a remaining gap small, that is not generating acoustic or fluidic short-circuiting and nevertheless allow movement of the moveable element 24. Such a gap may, for example, be obtained by removing or omitting a bonding layer between the layers 16 and 12 or 14, like by selectively etching or recessing a corresponding layer.

The moveable element 24 may also be moved from the first positioning illustrated by means of continuous lines to a second positioning illustrated by means of broken lines. A corresponding movement or change between the positionings 38₁ and 38₂ may comprise displacement of the moveable element 24, but advantageously comprises deforming the same.

The MMS 10 may comprise levels which are arranged in parallel to a so-called substrate plane which, in FIG. 1, is referred to as x/y plane, and may, for example, by understood to be a plane arranged in parallel to the one or more layers 12, 14 or 16 during a manufacturing process of the MMS 10. For example, main sides of wafers may be arranged in parallel to the x/y plane and thus define the substrate plane.

A direction z perpendicular thereto can be referred to as the stacking direction along which the layers 12, 14 and, optionally, 16 are stacked.

The moveable element 24 changes between the positionings 38₁ and 38₂ within the x/y plane, that is in-plane.

For example, when transitioning to the positioning 38₂, the moveable element 24 moves such that it is arranged beyond the opening 28 when reaching the positioning 38₂, illustrated by the axis 42. In the first positioning 38₁, the moveable element 24 may be located along the negative x direction starting from the axis 42 and, in the positioning 38₂, in the positive x direction starting from the axis 42.

This allows exposing the fluidic path between the openings 26 and 28 thereby allowing flow-through of the fluid 32 through the cavity 18.

The flow-through, among other things, along the stacking direction z results from the orientation of the openings 26 and 28, even if the openings 26 and 28 may be displaced to each other along the x direction and/or y direction.

In accordance with an embodiment, the MMS 10 may be formed as an overpressure valve and be configured to move, in the case of an overpressure at the first layer, in particular the main side 12A, the moveable element 24 from the positioning 38₁ to the positioning 38₂. This can be understood to mean that the fluid 32 may enter through the opening 26, for example, and causes an increase in pressure in the sub-cavity 34₁. This increase in pressure may cause when assuming a pressure difference relative to the sub-cavity 34₂, like the main side 14 of the layer 14, a force to be exerted on the moveable element 24 which results in the transition between the positionings 38₁ and 38₂.

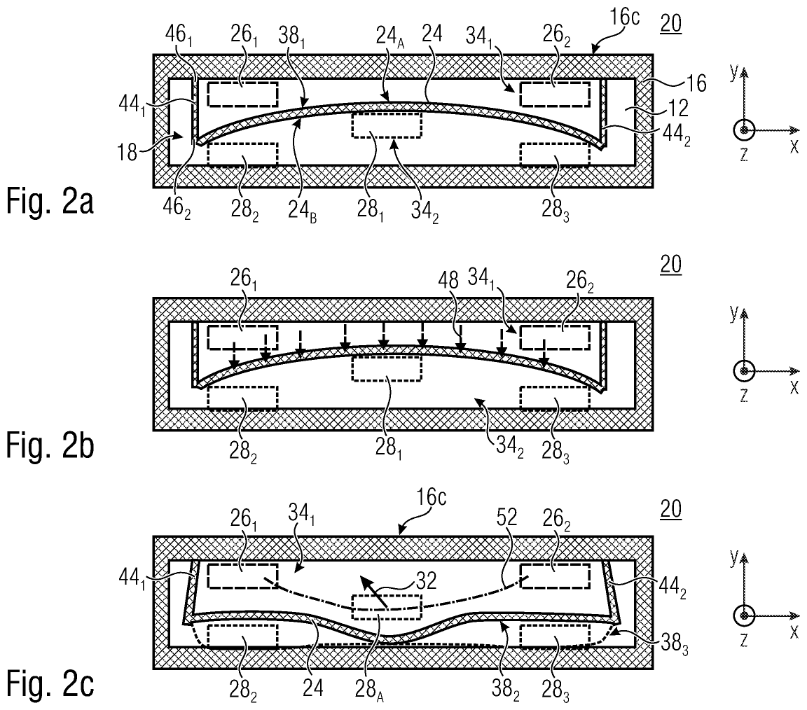

FIG. 2a shows a schematic top view of a part of an MMS 20 in accordance with an embodiment. The explanations for the MMS 10 also apply to the MMS 20. The moveable element 24 of the MMS 20 is connected to a side wall 16c of the layer on both sides via connecting elements 44₁ and 44₂.

The connecting elements 44₁ and 44₂ may, as does the moveable element 24, limit or inhibit or prevent fluid from transiting between the sub-cavities 34₁ and 34₂ to an at least relevant extent. This results in an appreciable inhibition of a flow-through of fluid through the sub-openings 26₁ and 26₂ towards the opening 28₁.

The connecting elements 44₁ and 44₂ may optionally be implemented at connecting positions 46₁ to the layer 16 and/or 46₂ to the moveable element 24 as a kind of solid-state joint or other elastic element, in particular with a rigidity which is smaller than or equaling the rigidity of the deflectable element, in particular to allow a certain flexibility along the positive and/or negative x direction.

When starting from the illustration in FIG. 2a where the movable element 24 is arranged in the first positioning 38₁, FIG. 2b shows a comparable illustration in which a pressure 48 forms in the sub-cavity 34₁, that is a pressure difference relative to the sub-cavity 34₂, for example when fluid flows into the sub-cavity 34₁ through the sub-openings 26₁ and/or 26₂. However, this equals fluid flowing out from at least one of the sub-openings 28₁, 28₂ and 28₃ in the layer 14 not illustrated here. An under-pressure in the sub-cavity 34₂ produced here has the same effect as an overpressure in the sub-cavity 34₁.

FIG. 2c shows a schematic top view of the MMS 20 in which the movable element 24 is in the second positioning 38₂, caused, for example, by the pressure 48. The valve is open, for example. This means that the moveable element 24 sweeps over the opening 28₁, for example, whereas it at least does not sweep completely over the openings 26₁ and 26₂. A fluidic path between the openings 26₁ and 26₂ on the one hand and the opening 28₂ can be exposed by the moveable element 24 and the fluid 32 flow correspondingly.

When exemplarily considering FIG. 2a, the moveable element 24 in a different arrangement of the openings and/or individual elements, may also sweep over the opening 26₁ and/or 26₂ and be deflected in this direction in order to also expose passage between the openings 26₁/26₂ on the one hand and 28₁, maybe additional openings in the layer 14, on the other hand.

Sweeping over in the context of this embodiment does not necessarily mean a certain arrangement in space in the sense of above or below since such relative terms, like front, back, left, right and further terms as well, are mutually exchangeable in space, for example by turning the MMS.

Sweeping over means that the moveable element 24 which is positioned in a different plane along the z-direction than the openings 26 and 28, passes the element swept over.

It is possible in accordance with embodiments that an amplitude of movement of the moveable element 24 is directly correlated to an intensity of the pressure 48. However, particularly advantageous embodiments provide MMS in which the second positioning 38₂, in a certain sense, is also a stable position which is achieved when the pressure 48 of FIG. 2b is strong enough to generate a deflection of the moveable element 24, but then a type of snap-through takes place which may cause a deflection or deformation of the moveable element 24, illustrated, for example, in FIG. 2c, which when at first reducing the pressure level of the pressure 48, remains stable until a certain lower pressure level is reached, which will be discussed below in greater detail.

What can also be gathered from FIG. 2c is that, due to the de-shaping or deformation of the movable element 24, the connecting elements 44₁ and 24₂ are deflected along the negative or positive x direction, which allows keeping material stress or tension in the moveable element 24 and/or the connecting elements 44₁ and 44₂ small while changing from the positioning 38₁ to the positioning 38₂ and/or back.

The state of FIG. 2a, that is the first positioning, may thus be described to be low-stress or, in a simplified manner, stress-free. This refers to a state in which a level of mechanical stress is small or minimum. In the positioning 38₂ of FIG. 2c, the moveable element 24 can comprise in contrast a high-stress state. While reducing this mechanical stress, the moveable element 24 can change back from the positioning 38₂ to the positioning 38₁. This means that, similarly to a deflected spring element, kinetic energy can be stored in the moveable element 34 and/or the connecting elements 44₁/44₂ so as to allow the movement back.

However, it is also conceivable for, with a further increase in pressure, although the second positioning 38₂ is reached already, a further positioning to be taken in which, for example, additional openings 28 are entered into the fluidic path so as to increase the measure of pressure increase. This means that it is possible that, in the second positioning, a first area of the second layer is opened for the fluidic path and, in an additional third positioning, a correspondingly increased area. The increase may be doubling but also any other factor and, for example, be set by dimensioning the openings 28₂ and/or 28₃.

In FIGS. 2a-c, it can also be recognized that the cavity 18 is subdivided into sub-cavities 34₁ and 34₂. By arranging additional elements, the cavity 18 may also be subdivided into a higher number of sub-cavities. The sub-cavity 34₁ is arranged on a first side 24A of the moveable element 24. The sub-cavity 34₂ is arranged on an opposite side 24B. This does not necessarily require a direct contact between a lateral area of the moveable element 24 and the fluid in the sub-cavity since, for example, additional elements may also be arranged on the side 24A and/or 24B, for example shiftable plates or the like. In this case, too, the sub-cavity 34₁ is fluidically coupled to the opening 26, or sub-openings 26₁ and/or 26₂. When changing from the positioning 38₁ to the positioning 38₂, a volume of the sub-cavity 34₁ is increased in embodiments until the sub-cavity 34₁ is also fluidically coupled to the opening 28₁ and/or 28₂ and/or 28₃ in the opposite layer 14 to allow the fluid 32 to flow through.

Increasing the sub-volume advantageously, but not necessarily means a volume content of the sub-cavity. However, the effect of clearing the fluidic path 52 can also be obtained when the sub-cavity 34₁ is, for example, at the same time reduced on a side facing away from the moveable element 24, for example if, instead of the side 16c, a further flexible element, like a moveable element connected in parallel, is arranged. Rather, it is sufficient if an opposite opening 28₁, 28₂ and/or 28₃ is fluidically coupled to the opening 26₁ or 26₂ by means of the movement and/or deformation so as to obtain the positioning 38₂.

In other words, FIGS. 2a-c show an MEMS or part of an MEMS 20 in top views, consisting of a deflectable element 24 which is connected to the surrounding substrate via connecting elements 44. Thus, the transition regions 46₁ and 46₂ are implemented such that the rigidity in this region is smaller than or equaling that of the deflectable element 24, the connecting element 44 and the substrate. In other words, a deformation of the deflectable element 24 and the connecting region 44 in the elastic region of the material used is possible so that these can return to their starting position after the deflection. Three different states of the MEMS 20 are illustrated. The state illustrated in FIG. 2a is the rest state of the deflectable element 24. It is arranged such that the overall cavity by the surrounding substrate 16, ground wafer 12 and cover wafer (not illustrated) is subdivided into a first sub-cavity 34₁ and a second sub-cavity 34₂. The height of the connecting element and of the deflectable element roughly corresponds to the height of the cavity so that the forming gap between the cover wafer, the movement elements and the ground wafer is minimal. The sensitivity relative to slow changes in pressure can be reduced by increasing the forming gap, that is in the case of a larger gap (like >10 um, for example), opening only takes place with sudden pressure peaks. An inhibited movement of the deflectable element and the connecting elements is to be possible, but without causing acoustic short-circuiting. In other words, a relevant volume flow between the two sub-cavities is to be prevented. The sub-cavities 34₁ and 34₂ are each connected to the surrounding fluid via openings 26 in the ground wafer 12 or openings 28 in the cover wafer 14 (not illustrated). Fluid may enter into the cavity via these openings or leak or be transferred from it.

FIG. 2b shows the MEMS 20, in a top view, in a time interval of the deflection method of the deflectable element 24. The pressure acting on the deflectable element 24 is illustrated at 48, resulting from filling the cavity 34₁ through the openings 26.

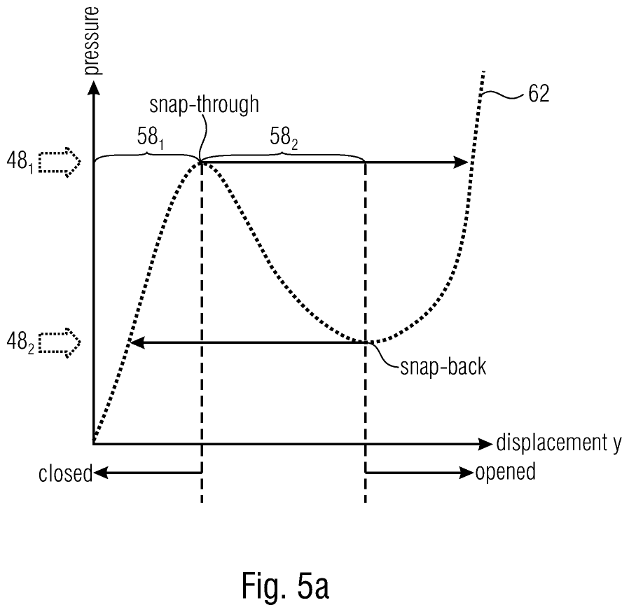

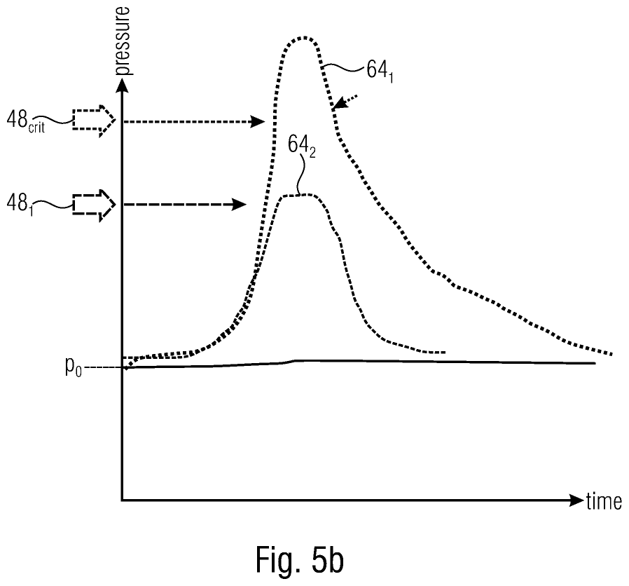

FIG. 2c shows the MEMS 20, in a top view, in a time interval of the deflection method where the acting pressure has exceeded the specific opening pressure of the deflectable element 24. The deflectable element 24 and the connecting elements take a new stress-induced position which is maintained for as long as the pressure value in the cavity 44 is between the specific opening pressure and the specific closing pressure. Thus, the volume of the sub-cavity 34₁ increases such that the sub-cavity is additionally connected to an opening 28₁ in the cover wafer 14 (not illustrated). Fluid can leak from the sub-cavity 34₁ through this opening, thereby causing a reduction in pressure in the sub-cavity 34₁. If the pressure decreases below the specific closing pressure, the deflectable element 24 and the connecting element 44 can take a stress-free state and return to its starting position, as will be discussed, for example, referring to FIG. 5a.

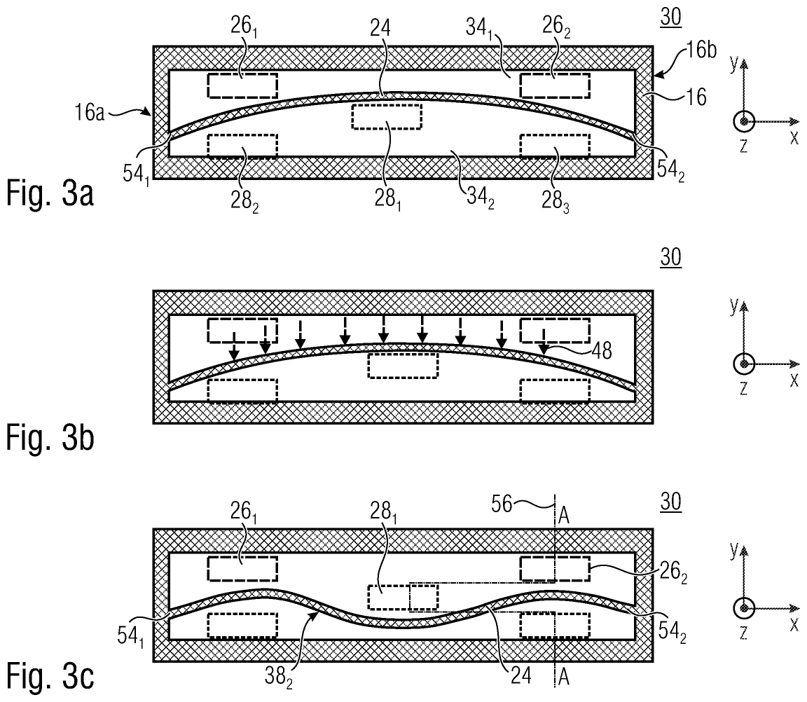

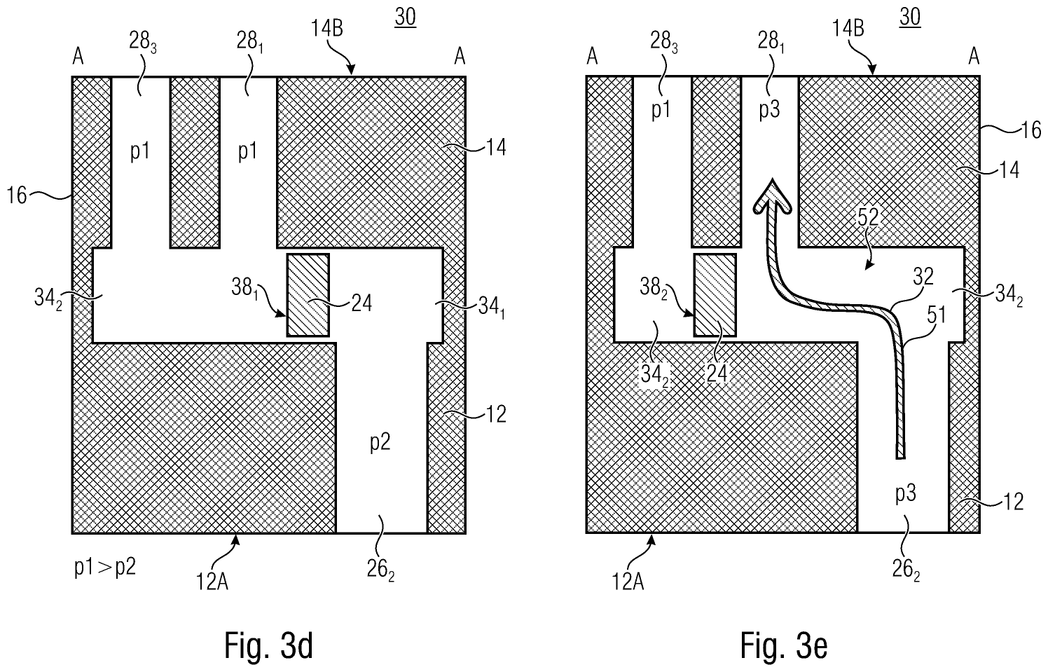

FIGS. 3a-c show schematic top views of an MMS 30 in accordance with an embodiment. When compared to the MMS 20, a comparable functionality can be obtained, however, the moveable element 24 can be suspended fixedly at beam ends and by means of mounting regions 54₁ and 54₂ on sides 16a and 16b of the layer 16, which can allow a manufacturing, which is easier when compared to the MMS 20, but may result in higher material stress in the moveable element 24. At the same time, as is illustrated schematically in FIG. 3c, a bending line, different when compared to the MMS 20, can be obtained in the state 38₂, which can be adjusted by implementing the fixing in the mounting regions 54₁ and/or 54₂. The moveable element 24 here can be considered like a bending beam and be implemented in correspondence with the mechanical basis knowledge of the person skilled in the art by orienting and/or implementing the mounting regions 54₁ and/or 54₂ relative to the bending line in the state 38₂.

In FIG. 3c, a sectional line 56 of the plane A-A is illustrated, which will be discussed in greater detail referring to FIGS. 3d and 3e, which each represent schematic sectional representations of the MMS 30 along the sectional axis A-A.

In FIG. 3d, the MMS 30 is illustrated in a state in which the moveable element 24 is arranged in the first positioning 38₁, which is comparable to the illustration of FIGS. 3a and 3b. At the same time, there is a pressure gradient between the sides 12A and 14B, due to a pressure p2 applied to the opening 26₂ of the layer 12, which is greater than a pressure p1 at the layer 14 or in the openings 28₁ and 28₃ or the side 14B.

As is described in connection with FIG. 3c, the result of this may be that the moveable element 24 changes to the second state 38₂ illustrated in FIG. 3e and exposes the fluidic path 52 through which the fluid 32 can flow, making it possible for the same pressure to be applied at both sides 12A and 14B of the MMS 30 and the pressure p2 of FIG. 3d to be reduced, which is illustrated by the pressure p3 which, when compared to the pressure p2, for example, is reduced and higher when compared to the pressure p1. The same, a different or no change in pressure may occur at the opening 28₃, which may be influenced by a temporal course and/or a setup in the cavity. In a further state, which is not illustrated, after the pressure has been reduced, the closing pressure of the valve may result up to which the fluidic path remains open. The remaining difference between p3 and p1 at the opening 28₃ may be defined, for example, by the closing pressure.

The opening 28₃ is thus illustrated only due to the sectional view. It can be seen here that for the functionality as a valve or overpressure valve, the opening 28₃ is not necessarily required.

The MMS 30 may, as does the MMS 20, see FIG. 2c, in the positioning 38₁ comprise a first bending line which can be recognized in the top view illustrated in FIGS. 2a and 3a. In the second positioning 38₂, a second bending line can be obtained, which can be recognized in FIGS. 2c and 3c. The second bending line may be geometrically dissimilar to the first bending line. Here, when the respective suspension remains the same, an asymmetrical force can be obtained when changing from the first positioning 38, to the second positioning 38₂ on the one hand and back to the first positioning 38₁ on the other hand.

In other words, FIGS. 3a to 3c show an alternative MEMS 30 in which the deflectable element 24 is connected directly to the surrounding substrate 16. The process of deflection does not differ from that of the MEMS 20.

FIGS. 3d and 3d show a sectional view along the section A-A in FIG. 3e. FIG. 3d illustrates that a cavity is formed between the ground and cover wafers 12 and 14 and the surrounding substrate 16 in the device plane. This cavity is formed by the two sub-cavities 34₁ and 34₂ which are separated from each other by the deflectable element 24. It is also illustrated that the openings 26 in the ground wafer 12 connect the sub-cavity 34₁ to the surrounding fluid. The openings 28 are arranged in the cover wafer 14 and connect the sub-cavity 34₂ to the surrounding fluid. FIG. 3e shows the moment of pressure compensation after the pressure in the sub-cavity 34₁ has increased and the deflectable element 24 is deformed into its stress-incurred position. Here, the sub-cavity 34₁ is connected to one of the openings 28 in the cover wafer 14, as a consequence of which a volume flow of the fluid 32 in the sub-cavity 34₁ transfers fluid from the sub-cavity 34₁ through the opening 28₁. The volume flow stops as soon as there is ambient pressure in the sub-cavity 34₁ or a lower pressure level is reached.

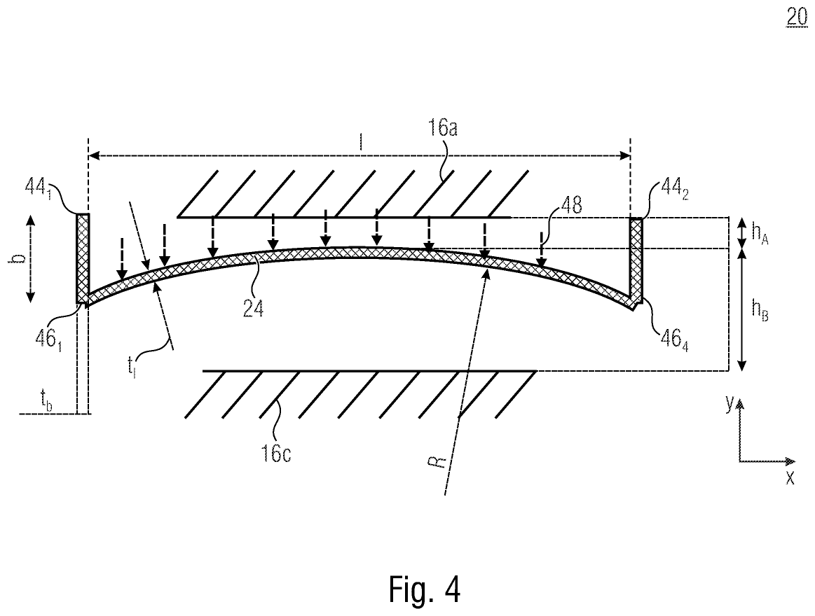

FIG. 4 shows a schematic top view of a portion of the MMS 20 of FIG. 2a for explaining possible, but not necessarily required implementation criteria and/or structural sizes.

FIG. 4a shows the deflectable element 24 connected to the connecting elements 44 by means of the connecting regions 46₂, 46₄. The surrounding substrate 16 is illustrated only in an abstract form. This illustration is to give information on the geometrical relations among the elements. The deflectable element 24 is illustrated in a non-deflected state, that is the material takes a low-stress state. In this state, the minimum distance between the element 24 and the substrate side 16a takes values between h_{A}=1 μm-100 μm, advantageously 20 μm to 40 μm. The distance to the substrate side 16b takes values between h_{B}=1 μm-100 μm, advantageously 20 μm-40 μm. Wherein h_{B} in this state of deflection will always be greater than h_{A}. Further geometrical parameters are the length l of the deflectable element 24, and the length b of the connecting elements 44. The parameter l takes values between 100 μm<l<9 mm. The length l of the deflectable element 24 and the length b of the connecting elements 44 are related as follows:

l/b>1

In other words, the length of the deflectable element may, for example, be greater than the length of the connecting element. Furthermore, the deflectable element 24 is characterized by the radius of curvature R. This radius is typically in a range of 50 μm<R<∞ or −∞>R>−50 μm. The radius R and the length l of the deflectable element are related as follows:

R/l>1/2

This means that the deflectable element may be a straight beam, or be implemented to be arc-shaped, like crescent-shaped.

The width of the deflectable element 24 is described by tₗ. The ratio of length and width of the deflectable element is characterized by the following relation:

tₗ/l<1

In other words, the width of the deflectable element will always be smaller than its length.

Furthermore, the connecting elements 44 comprise a width t_{b} which is in the following relation to the length b of the connecting element 44:

t_{b}/b<1

Thus, t_{b} may take values which are, for example, smaller than b.

It is to be pointed out that these expositions are only of an exemplary character for explaining embodiments.

A speed or velocity of the movement and/or reaction can be influenced via the parameters h_{A} and/or h_{B}. With a comparatively small value of h_{A} and h_{B}, the valve will close in a delayed manner, a so-called squeeze-film attenuation may occur. This allows, for example, setting comparatively short pressure impulses, comparable to an inert electrical fuse without the valve eliminating the entire pressure. When h_{A} and h_{B} are chosen to be comparatively large, the sensitivity can be increased at the expense of the structural size.

FIGS. 5a and 5b are used to discuss the multiply stable or at least partially stable implementation of the states of MMS 20 and MMS 30.

Thus, FIG. 5a shows a schematic function with a displacement of the movable element 24 on the abscissa when compared to a level of the pressure 48, as is illustrated, for example, in FIG. 2b, 3b or 4. FIG. 5a shows the illustrated information in an illustrative variation. What remains unchanged is that the displacement y of the movable element is a function of pressure p, that is y=f(p).

In a first section 58₁ of the illustrated curve 62, a direct relation can be set between the displacement, for example along the y direction, and the occurring pressure 48 or pressure level. This ratio may be linear, but this is not necessarily the case. When reaching a first pressure level 48₁, snap-through may take place and the positioning 38₂ illustrated, for example, in FIGS. 2c and 3c can be obtained. The displacement can occur in a region 58₂ in which a transition takes place between “closed” and “opened”, that is the two states may each occur partly and in combination with each other.

Rather, it can be recognized in FIG. 5a that reducing the pressure starting from the pressure level 48₁ does not result in an instantaneous back movement of the movable element, but snap-back will occur only when reaching a second, lower pressure level 48₂, which may also take place as suddenly as snap-through at the pressure level 48₁.

Using curves 64₁ and 64₂, FIG. 5b shows that the pressure level can, by means of the implementation of the pressure occurring in the cavity 18, as illustrated in FIG. 5a (curve 64₂), be kept such that a potential damage will no longer occur at a pressure level 48_{crit}. A pressure course, potentially from externally, in the cavity 18 is illustrated as curve 64₁, which would be obtained if there were no functionality of an overpressure valve implemented. However, curve 64₂ shows the pressure course in the cavity 18 with a valve arranged.

The pressure level 48_{crit} thus refers to a pressure level for a potential damage of the structures to be protected. The pressure level 48₁ refers to an opening pressure of the valve structure. The pressures are represented relative to an environmental pressure p₀. Overpressures may, for example, form in earphones when inserting them or taking them off.

As is discussed referring to FIG. 5a and the discussions relating to the MMS 10, 20 and 30, the MMS may be implemented such that, when applying a first pressure level of the fluid to the first layer, a change takes place from the first positioning to the second positioning and, when applying a second pressure level of the fluid at the first layer, a change back from the second positioning to the first positioning takes place, wherein the first pressure level is greater than the second pressure level. While changing the positioning, in particular back to the first positioning, this cannot be understood in particular to be a continuous decrease, due to a continuously reducing pressure, but, in accordance with embodiments, a sudden back movement (snap-back) when the stabilizing force in the movable element 24 is no longer sufficient to maintain the up to then stable position of the second positioning 38₂. This means that the change from the first positioning 38₁ to the second positioning 38₂ can be sudden or at least roughly sudden when the first pressure level has been reached. A then minor decrease in the pressure level may, when maintaining the first positioning 38₁, see FIG. 5, result in the movable element 24 to at first remain in the second positioning 38₂. Only if the pressure level has decreased sufficiently can a potentially sudden movement back to the first positioning 38₂ take place. As can be recognized in FIG. 5a, the closing pressure 48₂ may be smaller than the opening pressure 48₁. Embodiments allow implementing or defining these two pressures relatively freely relative to each other. Thus, depending on a requirement specified for a realized valve, or the respective application, a corresponding implementation.

In accordance with an embodiment, the movable element 24 may be configured to obtain, from the first pressure level, a deforming force for deforming the movable element 24 to the second positioning 38₂. When transitioning to the second positioning 38₂, material stress in the movable element 24₂ may at first increase and then decrease, which means that the stress level may decrease. This means that, after an initial increase, with a sudden movement to the second positioning 38₂, the material stress may decrease again, as is, for example, known in bi-stable, tri-stable or multiply stable deformations of deformable elements. In contrast to a bi-stable element, the movable element 24 in embodiments, however, is implemented such that a sufficiently large reduction in pressure is sufficient for obtaining movement back to the, in turn, stable first positioning 38₁. This means that the movable element 24 may be configured to take a stable state, that is the positioning 38₂, based on the reduction of the material stress, which may be maintained until the second pressure level is obtained or fallen below, when starting from the first pressure level.

The movable element 24 may be configured to change, based on an increase in pressure of the fluid at the first layer, that is a first side of the movable element 24, to the second positioning 38₂ to at first, when the pressure decreases, remain in the position of the second positioning until the second pressure level is reached. This movement back may be based on mechanical stress, that is not be induced due to the pressure alone. This means that the back movement or the energy used for this can be stored in the material of the movable element 24 and/or its suspension when taking the second positioning 38₂, starting from the first positioning 38₂.

In embodiments described here, a pressure difference between the first layer and the second layer is emphasized. These differences in pressure particularly arise while avoiding acoustic or fluidic short-circuiting between the external layers of the fluid or the first layer 12 and the second layer 14. This may particularly be obtained when an MMS described here is used unidirectionally or bidirectionally as a functional structure in a system, for example as an overpressure valve of such a system. Earphones or the like may, for example, be considered to be such a system, wherein, for example, when considering the auditory canal of humans, acoustic short-circuiting of such structures can be prevented.

FIG. 5a graphically shows the deflection behavior of a deflectable element 24 in accordance with an embodiment. What is illustrated is the pressure in the first sub-cavity 34₁ relative to the displacement or deformation of the deflectable element 24. It is to be recognized here that the deflectable element 24, after exceeding the opening pressure, deforms and remains in the so-called snap-through positioning, that is the positioning 38₂, until the pressure in the first sub-cavity 34₁ takes a value between the opening and closing pressures. As soon as the value has decreases below the closing pressure, the deflectable element 24 falls back to its original position, that is the positioning 38₁. This point is also referred to as snap-back. The closing pressure will always be smaller than the opening pressure, wherein the closing pressure may also take negative values.

With a valve using the MMS described here, the pressure course in a chamber can be adjusted such that the pressure level which would result in a potential damage of the structures to be protected, see FIG. 5b, is not reached. As soon as the valve is opened, the pressure will usually not increase further and decreases until, depending on the implementation, either the closing pressure or the surrounding pressure is reached (see full line).

As has been discussed, for example, using the MMS 20 and the MMS 30, the movable element 24 can comprise a beam structure suspended on both sides, which, relative to an undeflected reference positioning, for example a straight or un-deformed or unstressed beam structure, is curved along a first direction, for example the positive y direction. Even if embodiments do not exclude a pre-deflection of the element during or after manufacturing, the deflectable element 24 may advantageously be manufactured already in the form illustrated, for example by means of a selective eroding process, like an etching process or a selective generating process of material adding. The movable element 24 may be configured to perform, when changing to the positioning 38₂, a deflection in a, relative to the reference positioning, second direction which is, for example, opposite to the first direction, that is the negative y direction.

Even if the reference positioning referred to does not necessarily have to be taken, the situation will nevertheless arise that this reference positioning is to be overcome. While the MMS 20, for example, suggests the connecting elements 44₁ and 44₂, for example, for simplification, the MMS 30 of FIGS. 3a-c may also be implemented using a fixed suspension, which may entail higher forces for maintaining the positioning 38₂, but is also able to allow a more stable position in the positioning 38₂. In particular, stress relaxation of the movable element can be made use of to a high extent up to maximally. The stress relaxation allows bi-stability and may arise when the at first curved element is stressed or deformed using pressure. Due to the suspension, and in FIGS. 3a-c, the stress relaxation may be set to be used to adjust the relation between opening and closing pressure.

In accordance with an embodiment, the movable element 24 may be held, at at least a first side, by a retaining element 44₁ and 44₂ associated to the first side, at a cavity wall of the cavity 18. In FIGS. 2a-c, this is illustrated for both sides or both ends of the beam structure of the movable element 24. The movable element 24 may be curved in the first positioning 38₁ and be configured to deform, with a change to the positioning 38₂, at first against the curvature. The retaining element 44₁ and/or 44₂ may be implemented as a spring suspension of the movable element.

Even if the MMS 20 is illustrated such that, both at a first side/end and at a second side/end facing away from the first side, the movable element 24 is held by a respective retaining element 44₁ and 44₂, but asymmetrical or unequal mountings may also be used, as will be discussed below. In particular, making reference to FIG. 1, one-sided mounting or suspension may also be realized.

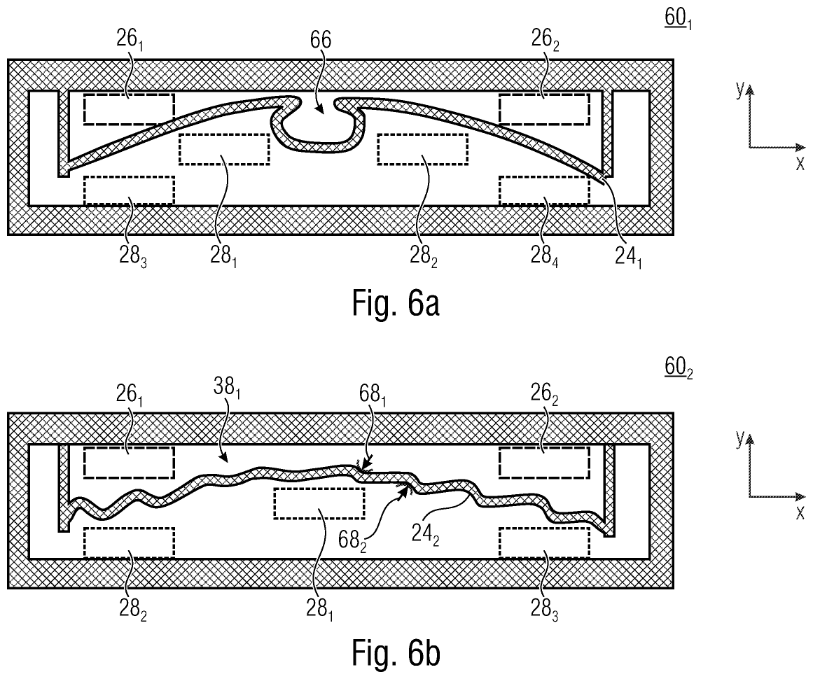

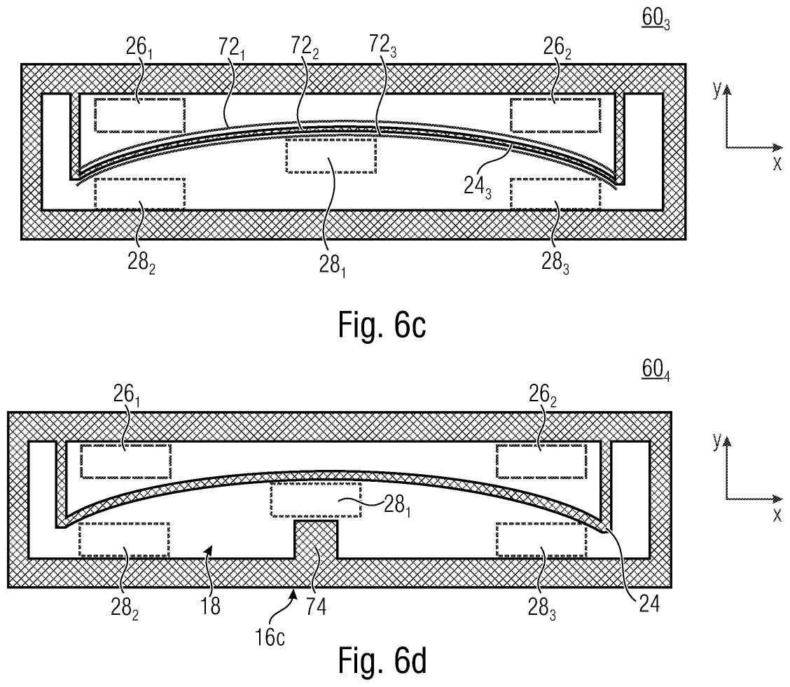

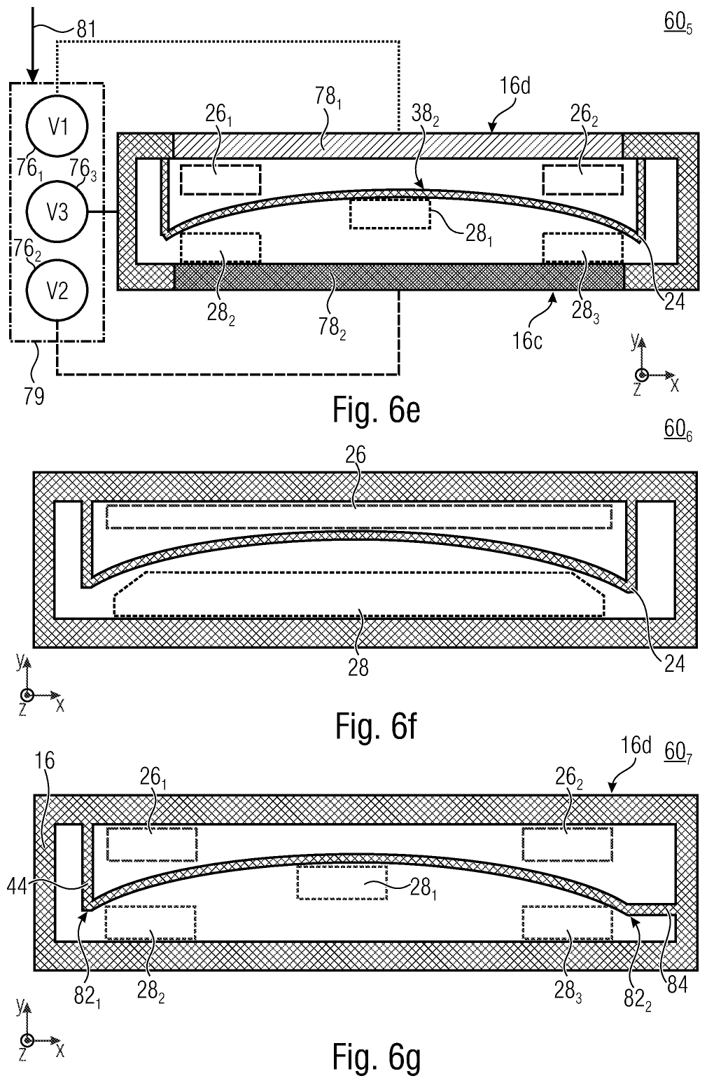

Some possible implementations of an MMS or the movable element 24 will be discussed below referring to FIGS. 6a-6g. Even if different advantageous implementations are described in different figures, the implementations may easily be combined with one another.

FIG. 6a shows a schematic top view of parts of an MMS 60₁ in accordance with an embodiment. When compared to the MMS 20, the movable element 24₁ may comprise a local weakening 66. The local weakening 66 may, for example, be implemented as additional material or an additional axial extension. In the example of FIG. 6a, this is an inner arc which points opposite along the positive y direction and thus points in a negative y direction, relative to the outer arc of the remaining movable element 24, which is illustrated exemplarily in FIG. 2a.

In FIG. 6b, a schematic top view of parts of an MMS 60₂ is shown in which a movable element 24₂ comprises a wave-shaped or zigzag-type bending line, when compared to the MMS 20. In the positioning 38₁ illustrated, a bending line projected into the substrate plane may comprise a plurality of continuous (wave-shaped) or discontinuous (zigzag or bent) changes of a sign of a radius of curvature. Thus, a radius of curvature 68₁ may comprise a first sign relative to a curvature along the positive x direction and an inverse sign for a subsequent radius of curvature 68₂ along the x direction.

FIG. 6c shows a schematic top view of parts of an MMS 60₃ in accordance with an embodiment, wherein a movable element 24₃ may comprise a plurality of at least two, at least three or more layers 72₁, 72₂ and 72₃ arranged next to one another in parallel to the substrate plane. The at least two layers may comprise mutually different materials, mutually different electrical potentials, mutually different material thicknesses or the like, but be implemented to be equal in one or more of these characteristics. This means that, in embodiments, two of the more layers may also be spaced apart from one another at least in regions, the layers may be mechanically fixedly fixed to one another at the discrete regions or not, without differing among one another.

The movable element 24₃ may, for example, be used as a multi-layer component, a composite component, using a meta material, a piezo material, or a special geometry. A meta material can be understood to be a material which can be generated by small periodic patterns, which has effective characteristics which cannot be found in this form in naturally occurring materials, like auxetic material or phonon crystals, for example.

A so-called nanoscopic electrostatic drive (NED), for example, can be mentioned as a special geometry in which the layers are electrically insulated from one another and/or mechanically fixed to one another at least in discrete regions, and applying an electric potential difference between two neighboring layers allows an electrostatic force of attraction which may allow deflection of the movable element 24₃ and/or be used as a sensor characteristic for detecting a deflection generated by means of pressure. Thus, using an electrical potential, when correspondingly designing the movable element 24₃, for example, an adjustment of the bending line and/or the switching points of FIG. 5a may be set by introducing electrostatic forces into the movable structure 24₃ in addition to the pressure of the fluid.

FIG. 6d shows a schematic top view of at least parts of an MMS 60₄ in accordance with an embodiment. When compared to the MMS 20, the MMS 60₄ comprises a mechanical element 74 which extends into the cavity 18 starting from a cavity 216c and is configured to restrict deflection of the movable element 24 or another movable element described herein by mechanical contact to the movable element 24 starting from the positioning 38₁. This allows avoiding damage in the movable element 24 due to excessive pressures since deflection beyond the desired positioning 38₂ can be restricted.

The mechanical element 74 may be cuboid or shaped differently as desired, for example be rounded, rod-shaped or comprising several components.

FIG. 6e shows a schematic top view of parts MMS 60₅ in accordance with an embodiment. Here, the movable element 24 is active and formed for obtaining a drive signal, wherein the drive signal may be considered to be a potential difference between signal sources 76₁ and 76₃ and/or 76₂ and 76₃. Even if the signal sources 76₁ and 76₃ are illustrated such that separate electrical potentials may be applied to a first electrode 78₁ arranged at a cavity wall 16d and an electrode 78₂ arranged oppositely at the cavity wall 16c, the signal sources 76₁ and 76₂ may also apply an identical potential or potential of equal magnitude and, for example, be driven in a temporally alternating manner.

The electrodes 78₁ and/or 78₂ may be implemented, for example, at or in the layer 16. Electrically conductive materials may, for example, be arranged for this and/or an electrical conductivity of a material of the layer 16 in regions may be produced, for example by doping a semiconductor material.

The electrodes 78₁ and 78₂ may be arranged such that an electrical capacitor may each be formed in connection with the movable element 24, the direction of effect of which is arranged in parallel to the substrate plane, that is in parallel to the x/y plane so that a respective electrical potential between the electrode 78₁ and the movable element 24 and/or the electrode 78₂ and the movable element 24 results in support and/or impeding of a deflection of the movable element 24 in the positive or negative x direction.

Here, the MMS 60₅ may be obtained as a valve which is settable electrostatically with regard to one or more switching times from FIG. 5a or which may even be actuated electrically. In accordance with the embodiment illustrated, the movable element 24 may be implemented actively and for obtaining a drive signal and be configured to change, based on the drive signal, pressure sensitivity for the fluid for a change from the positioning 38₁ to the positioning 38₂, not illustrated, or vice versa. Alternatively or additionally, it is also possible for the movable element, for example with different signal amplitudes, to perform a change from the first positioning (38₁) to the second positioning (38₂) and/or vice versa based on the drive signal (76₁ to 76₃), that is be controlled actively. It is to be mentioned that the three beam structures are selected only exemplarily and that a different number of beams may be implemented, like at least one, at least two or more than three, like four, five or six or more, for example.

As has been discussed already in connection with FIG. 6c, the electrode structures of the MMS 60₅ may also be used for a sensor functionality, for example to form a sensor element which is implemented to provide a sensor signal associated to a state of deflection of the moveable element 24. Alternatively or additionally, a corresponding sensor element may also be provided in addition to the signal sources 76₁, 76₂ and 76₃. In accordance with embodiments, an MEMS may comprise a closed control loop (feedback/regulation) to set the characteristics of the moveable element due to a determined deflection or determined behaviour.

This means that control means 79 may be provided which is configured to drive the signal sources 76₁, 76₂ and/or 76₃, and which may optionally be configured to obtain a sensor signal 81 which indicates the state of deflection. It may also be implemented to obtain only the sensor signal 81, without providing the voltage sources 76₁, 76₂ and/or 76₃.

FIG. 6f shows a schematic top view of parts of an MMS 60₆ in which a size of an area of the opening 26 is different when compared to the size of an area of the opening 28. The size of an area here is understood to be an area extension which may, for example, be indicated in nn², μm² or mm².

Alternatively or additionally, an area shape of the opening 26 may differ from an area shape of the opening 30. Exemplarily, the opening 26 may be rectangular and the opening 28 may be formed to be trapezoidal. Both differences may be implemented independently of each other or together. Whereas different sized of the areas of the openings 26 and 28 can set the attenuation behaviour also with regard to a system in which the MMS is used, the area shape may, for example, be adjusted to the bending line or position of the moveable element 24 in the first positioning and/or the second positioning.

FIG. 6g shows a schematic top view of parts of an MMS 60₇ in accordance with an embodiment in which the moveable element 24 is suspended asymmetrically. While, for example, the connecting element 44, which may extend along the positive y direction towards the substrate plane 16, like the side 16d, is provided at a first end 82₁, an opposite second end 82₂ may be either suspended fixedly or, as is illustrated, be formed by means of a soft connecting element 84 or one implemented as a spring element, which in its characteristic is basically similar to the connecting element 44, but may comprise a different orientation, for example, in parallel to the x direction, a different thickness and/or length. In other words, FIG. 6g shows an MMS with an asymmetrical suspension of the moveable element 24, wherein the moveable element 24 is nevertheless suspended on both sides.

FIGS. 6a-6g show several alternative embodiments of MMS/MEMS which differ relative to the implementation of the deflectable elements. The illustration is to publish that the design of the deflectable elements may have significant influence on the deflection and response behaviour. For example, different response pressures may be addressed/are settable by beams of local weakening, see FIG. 6a, or complex geometries, see FIGS. 6a-b, or the volume settable for the pressure reduction in the sub-cavity. The rigidity, mass and attenuation of the deflectable element may be manipulated by the multi-layer, composite or meta materials as a material for an alternative deflectable element, see FIG. 6c, to better match the opening pressure, the closing pressure, the opening stroke, the eigenfrequency, the reaction time for the respective application. Additionally, it is possible to generate additional internal stress in the deflectable element by such materials, which may change the equilibrium of forces, to allow even faster responses, for example. Piezo resistive materials may also be used, thereby generating a defined electrical signal for detecting the opening. Capacitive feedback is also possible when using an NED-based deflectable element.

The MMS/MEMS of FIG. 6d suggests an embodiment which is equipped with a stop 74 for the deflectable element 24. It is of advantage here that the volume of the respective sub-cavities can be set more precisely when applying a pressure. Additionally, the induced voltage in the material of the deflectable element 24 in the deflection position is minimized, resulting in an increase in the lifetime of this MEMS component.

An embodiment of an MMS/MEMS of FIG. 6e shows an actively deflectable element. Here, for example, parts of the surrounding substrate are connected to a first and second signal voltages. A third part of the substrate which is also connected to the deflectable element 24 is provided with a third electrical signal. All the signals are connected to a corresponding control device 79 and electrically separated from one another by electrically insulating elements. This embodiment aims at suggesting a settable overpressure valve. By applying corresponding signals, the rigidity of the deflectable element and, thus, the response behaviour may be influenced. In addition, it is also possible to keep the deflectable element in one of its two positions.

The embodiment of an MMS/MEMS of FIG. 6f shows the arrangement of large openings 26 and 28 and implies that the person skilled in the art is able to adjust the implementation of the openings in the cover and ground wafers in accordance with the object set.

The embodiment of an MMS/MEMS of FIG. 6g shows an asymmetrical arrangement of the connecting elements 44. Here, the deflection behaviour of an element 10, in particular when moving back to the starting position, can be influenced positively (hysteresis).

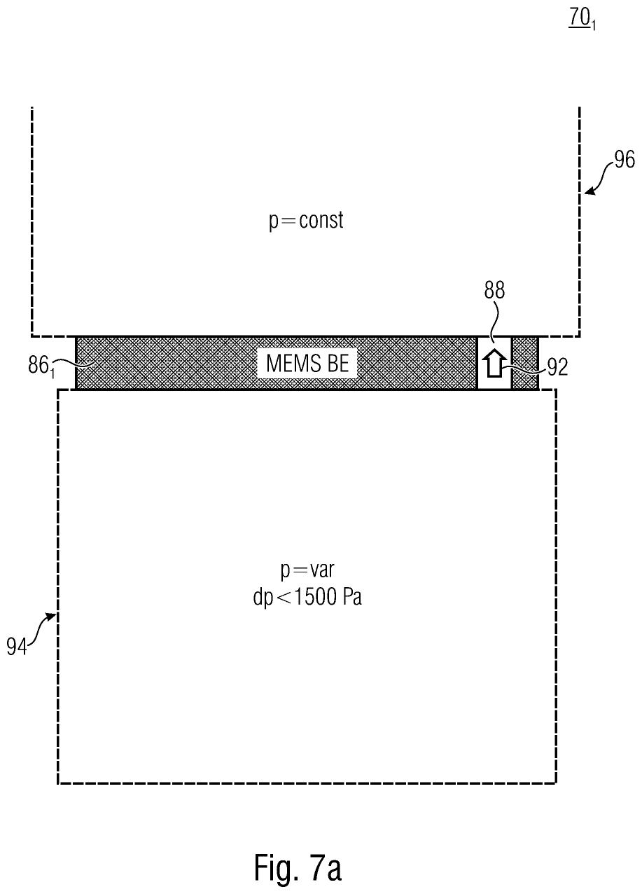

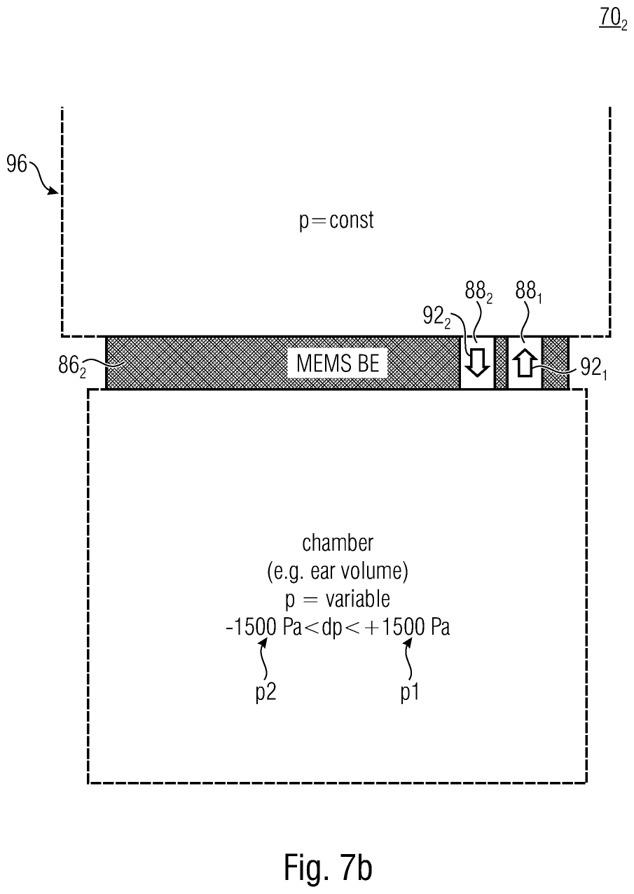

FIG. 7a shows a schematic block circuit diagram of a system 70₁ in accordance with an embodiment. The system 70₁ comprises an inventive MEMS device (MEMS BE) 86₁ in accordance with an embodiment, having an MEMS valve 88 which may be formed, for example, as an MMS 10, 20, 30, 60₁ to 60₇, or comprise such an MMS/MEMS. Due to the orientation of the MEMS device 86₁, a valve direction 92 can be set by orienting the layers 12 and 14 since the MMS 10, 20, 30 and 60₁ to 60₇ may comprise a flow direction from the layer 12 to the layer 14.

By means of the MEMS device 86₁, a volume or chamber 94 can be separated from another volume or an outside environment 96. While a pressure p may be constant at least basically, for example, in the environment 96, a change in pressure may occur in the volume 94. A corresponding change in pressure may, for example, be generated if a so-called in-ear earphones or a different form of earphones is introduced into an auditory canal or taken out. A difference in pressure may be generated by the restricted volume and the relatively marked change in volume.

Making reference to FIG. 5a, a trigger pressure, for example, like the first pressure level, can be set such that it is above a threshold value of dp of 1500 Pa or at 1500 Pa. As long as an actually occurring difference in pressure dp is below 1500 Pa, the valve 88 may remain in the first positioning and be triggered when this pressure is exceeded, which is meant to be avoided in correspondence with the system implementation, to reduce the pressure in the volume 94. The overpressure valves described here may be set such that they are triggered with pressures of at most 5000 Pa, advantageously at most 2000 Pa and, particularly advantageously, at roughly 200 Pa.

FIG. 7b shows a schematic block circuit diagram of a system 70₂ in accordance with an embodiment. When compared to the system 70₁ in which a valve 88 is provided for a unidirectional reduction in pressure, the system 70₂ or the MEMS device 86₂ may comprise two valves 88₁ and 88₂ having MMS/MEMS described herein. When exemplarily making reference to the earphone example in which the volume 84 may represent the ear volume, the system 70₁ may be implemented such that, when inserting the earphones into the auditory canal, an overpressure forming there is reduced by means of the valve 88.

When taking them out, a corresponding under-pressure may be formed, which the valve 88 may only be able to correct to a limited extent.

Thus, two valves having opposite valve directions 92₁ and 92₂ are provided in the system 70₂ or MEMS device 86₂. The two valves 88₁ and 88₂ may comprise an equal triggering pressure of, for example, 1500 Pa, once in the positive direction for the valve 88₁ and once in the negative direction for the valve 88₂.

Although the system 70₂ having two mutually different valves is illustrated, which are adapted along opposite directions for fluid flow-through, embodiments also provide for a bi-directional MEMS valve. Here, for example and making reference to FIG. 2a, a first fluidic path 52 is provided between the opening 26 and the opening 28, see FIG. 2c. It is adjusted for reducing a fluid pressure at the first layer 12 and blocking by the moveable element 24 in the first positioning 38₁ of the moveable element 24. The MMS may comprise a second fluidic path configured to reduce a fluid pressure at the second layer by transporting the fluid towards the first layer, that is in an opposite direction, wherein the moveable element 24 or another element moveable in parallel to the substrate plane is configured to inhibit fluidic flow-through through the second fluidic path at times and to allow the same at times. Thus, for example, a third positioning of the moveable element 24 of FIGS. 2a-c or 3a-c may be provided to connect at least one opening in the first layer 12 to at least one opening of the second layer. Alternatively or additionally, a correspondingly implemented additional moveable element may be provided, configured to connect at least one opening in the first layer 12 to at least one opening of the second layer when the additional element comprises the corresponding second positioning.

Embodiments relate to a system comprising an MMS/MEMS in accordance with an embodiment as described herein. Such a system may, for example, comprise an overpressure valve having a corresponding MMS, or the MMS may be implemented to be the overpressure valve. Exemplary systems are, for example, earphones or any other implementation forms which comprise an overpressure valve having the features as described herein.

FIGS. 7a and 7b show the basic functionality of the overpressure valve disclosed. Thus, the chamber exemplarily represents the volume in the external auditory canal between the MEMS device and the eardrum. By different events, like removing or inserting an MEMS device into the auditory canal, the pressure in the auditory canal may be subjected to sudden variations. FIG. 7a shows the case of inserting an MEMS device and an increase in pressure, implied by this, which can be compensated by opening the valve. FIG. 7b shows the case that a negative pressure may also occur very suddenly in the auditory canal and the pressure has to be compensated.

An inventive object which is achieved by embodiments is providing a device which protects the internal space of an MEMS-based sound transducer from too strong or suddenly occurring difference in pressure. Due to such differences in pressure, it is possible for the actuators arranged in the MEMS to be subjected to high mechanical stress and, consequently, to be destroyed.

The inventive solution is made by the device which is advantageously implemented to be passive and arranged in the cavity of an MEMS-based sound transducer. The passive deflected element is arranged in the cavity and connected to the surrounding substrate such that its separates the cavity into two sub-cavities. Thus, lower outlet openings are associated to the first sub-cavity and upper outlet openings to the second sub-cavity.

When exceeding a specific pressure which may, for example, occur suddenly and act on a passively deflectable element, it will deform and take a stress-induced geometrical shape. As long as the difference in pressure is maintained, stress-induced force and the pressure-induced force are balanced and the passively deflectable element will remain in this position. If the pressure-induced force decreases, the stress-induced force will dominate and the deflectable element return to its low-stress state.

The difference in pressure in the cavity is caused when the fluid enters into the same via the openings in the cover wafer. If the defined opening pressure is exceeded by this suddenly occurring pressure surge, the passive element will be deformed such that the geometrical association of one or more outlet openings changes from one sub-cavity to the other sub-cavity, which may allow/result in a pressure compensation between the outlet openings associated to one of the same sub-cavity.

The present invention relates to a micro-mechanical system (MMS) or micro-electromechanical system (MEMS), configured to dissipate overpressures, which may occur, for example, in a loudspeaker arranged in the auditory canal of a user, from the auditory canal and the loudspeaker. Overpressures form, for example, when the loudspeaker is introduced into the auditory canal or removed from it. Such suddenly occurring overpressures are damaging to the sound transducers since they may result in mechanical deformations of the sound transducers. Furthermore, such MEMS-based overpressure valves are not restricted to this field of application. In other words, the present invention suggests a protection device for sound transducers in the case of pressure variations, thereby preventing mechanical overstressing. Additionally, the present invention may also contain other features for other MEMS-based devices, like pumps, switches and adjustable capacitors.

The MMS/MEMS devices suggested here are layer stacks which consist of at least one substrate layer in which the optional electrodes and the passive elements are arranged. Further layers relate to a ground, which is also referred to as handling wafer, and a cover, which is also referred to as cover wafer. Both the cover and handling wafers are connected to the substrate plane via material-to-material methods, advantageously bonding, thereby forming acoustically sealed intermediate spaces in the device. The deformable devices deform within the gap, which corresponds to the device plane, in other words, deformation is in-plane.

The layers may, for example, comprise electrically conductive materials, like doped semiconductor materials and/or metal materials, for example. The layer arrangement of electrically conductive layers allows a simple implementation, since electrodes (for deflectable elements) and passive elements may be formed by selectively dissolving from the layer. In case electrically non-conductive materials have to be provided, the layer deposition of these materials is done by means of deposition methods.

This means that the moveable element 24 may be configured to comprise alternatingly the first positioning 38₁, the second positioning 38₂ and the third positioning 38₃, that is one of the positionings mentioned at one time. A higher amount of fluid may flow through the cavity in the third positioning 38₃ than in the positioning 38₂.
The present invention shows design guidelines for implementing an overpressure valve. Consequently, the inventors have decided to relate the geometrical parameters so as to provide a device pursuant to the design parameters connected to this. Aspects of the present invention relate to the following:
MEMS contains a deflectable element
   the deflectable element has a stress-free (mechanical) basic position
   when exceeding the opening pressure in the first sub-cavity, the deflectable element takes a new position which generates mechanical stress in the material
   as long as the pressure is maintained, the pressure-induced force which acts on the deflectable element, and the stress-induced force are balanced. This means that the deflectable element will remain in its position
   if the pressure falls below the closing pressure, the stress-induced force is greater than the pressure-induced force and the deflectable element returns to its low-stress state
   zigzag and wave-shaped geometries are conceivable in order to optimize an opening pressure or opening paths
   there may be many more than only two stable positions, for example, a beam resulting in a small opening with a defined through-flow at a first opening pressure and only suddenly opens up a big hole at a second opening pressure.
Embodiment
   It is possible for a beam to be generated by coating techniques, like polysilicon, which is not stress-free in the starting position. This strategy may be of advantage.
Embodiment
   The deflectable element in one embodiment may be actively deflectable
   For example, in the implementation as an ANED (asymmetrical nanoscopic electrostatic drives, like two beams connected to each other), LNED (lateral nanoscopic electrostatic drives, as described, for example, in WO 2012/095185 A1) or BNED (balanced nanoscopic electrostatic drive, as described, for example, in WO 2020/078541 A1)
   Active setting of the opening pressure and the closing pressure by additional electrostatic forces, advantageously using DC voltage
   Active opening and closing by additional electrostatic forces, DC voltage or AC voltage
Embodiment:
   Deflectable element may generate signals to indicate opening and closing
   Capacitive feedback by arranging electrodes in the cavity
   Capacitive feedback by using NED-based deflectable element
   Piezoresistive feedback by using piezoresistive materials for the deflectable element
Overpressure protection device of MEMS-based devices
   beam structure arranged in the cavity (design adjusted to opening pressure and closing pressure)
   moves in-plane between the ground and cover wafer layers
   is triggered at pressures of smaller than 5000 Pa, advantageous pressure is smaller than 2000 Pa and, particularly advantageously, smaller than 1,500 Pa, wherein a possible upper threshold is atmospheric pressure.
   Closes when falling below a closing pressure
   Passive by means of snap-through functionality
      may take two low-stress states, depending on the pressure conditions in the cavity.
      State 1: Sound transducer cavities closed relative to the environment as soon as closing pressure is fallen below.
      State 2: Sound transducer cavities connected to the environment as soon as opening pressure is exceeded.

Only very small masses are moved over very small distances.

Although some aspects have been described in the context of an apparatus, it is understood that these aspects also represent a description of the corresponding method so that a block or component of an apparatus is also to be understood to be a corresponding method step or a feature of a method step. In analogy, aspects described in connection with or as a method step also constitute a description of a corresponding block or detail or feature of a corresponding apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An MMS comprising:
a first layer comprising a first opening for letting pass a fluid;
a second layer arranged opposite the first layer and comprising a second opening for letting pass the fluid and forming, together with the first layer, at least a part of a layer stack comprising layers stacked in a stacking direction which is perpendicular to a substrate plane of the MMS;
a cavity arranged between the first layer and the second layer;
an element arranged in the cavity and moveable along a direction in parallel to the substrate plane, which alternatingly comprises at least a first positioning and a second positioning, wherein, in the first positioning, flow-through of the fluid is inhibited; and, in the second positioning, flow-through of the fluid through the cavity along the stacking direction is allowed.

2. The MMS in accordance with claim 1, formed as an overpressure valve and configured to move, with an overpressure at the first layer, the moveable element from the first positioning to the second positioning.

3. The MEMS in accordance with claim 1, wherein a first fluidic path is arranged between the first opening and the second opening, implemented for reducing a fluid pressure at the first layer and blocked in the first positioning of the moveable element; wherein the MMS comprises a second fluidic path configured to reduce a fluid pressure at the second layer by transporting the fluid towards the first layer; wherein the moveable element or a further element moveable in parallel to the substrate plane is configured to inhibit at times and allow at times fluidic flow-through through the second fluidic path.

4. The MMS in accordance with claim 1, wherein the first opening and the second opening are arranged to be offset to each other when projected to the substrate plane; wherein the moveable element is configured to at least partly sweep over, when changing from the first positioning to the second positioning, one among the first opening and the second opening; and not to sweep over the other opening.

5. The MMS in accordance with claim 1, wherein the moveable element is configured to subdivide the cavity into at least a first sub-cavity arranged at a first side of the moveable element and a second sub-cavity arranged at a second side, which is opposite the first side;
wherein the first sub-cavity is fluidically coupled to the first opening and the moveable element is configured to increase, when changing from the first positioning to the second positioning, a volume of the first sub-cavity until the first sub-cavity is fluidically coupled to the second opening and allows flow-through of the fluid.

6. The MMS in accordance with claim 1, wherein the moveable element, in the first positioning, comprises a low-stress state of mechanical stress and is configured to comprise, in the second positioning, a high-stress state to change back from the second to the first positioning while reducing mechanical stress.

7. The MMS in accordance with claim 1, configured to change from the first positioning to the second positioning when applying a first pressure level of the fluid at the first layer; and to change, when applying a second pressure level of the fluid at the first layer, back from the second positioning to the first positioning; wherein the first pressure level is greater than the second pressure level.

8. The MMS in accordance with claim 7, wherein the moveable element is configured to acquire, from the first pressure level, a deforming force for deforming the moveable element to the second positioning, wherein, when transiting to the second positioning, a material stress is subject at first to an increase and, subsequently, to a decrease, wherein the moveable element is configured to take a stable state, based on the decrease in material stress, until the second pressure level is reached or fallen below, starting from the first pressure level.

9. The MMS in accordance with claim 7, wherein the moveable element is configured to change to the second positioning based on an increase in pressure of the fluid at the first layer and to remain in the second positioning with a decrease in pressure, based on mechanical stress, until the second pressure level is reached.

10. The MMS in accordance with claim 1, wherein the moveable element comprises a beam structure suspended on both sides which, relative to an undeflected reference positioning, is curved along a first direction; wherein the moveable element is configured to perform, when changing to the second positioning, a deflection in a second direction relative to the reference positioning.

11. The MMS in accordance with claim 1, wherein the moveable element is held, at at least a first end, at a cavity wall of the cavity by a retaining element associated to the first end; wherein the moveable element is curved in the first positioning and configured to deform at first against the curvature when changing to the second positioning; wherein the retaining element is formed as a spring suspension of the moveable element.

12. The MMS in accordance with claim 11, wherein the retaining element is a first retaining element and the moveable element is held by a second retaining element at a second end facing away from the first end.

13. The MMS in accordance with claim 1, wherein the moveable element, in the first positioning, comprises a first bending line in parallel to the substrate plane and, in the second positioning, comprises a second bending line which is geometrically dissimilar to the first bending line.

14. The MMS in accordance with claim 1, wherein the moveable element comprises a beam structure bendable in parallel to the substrate plane, comprising a local weakening of a beam rigidity.

15. The MMS in accordance with claim 1, wherein the moveable element, in the first positioning comprises a bending line projected into the substrate plane, which comprises a plurality of continuous or discontinuous changes of a sign of a radius of curvature.

16. The MMS in accordance with claim 1, wherein the moveable element comprises a plurality of layers arranged next to one another in parallel to the substrate plane.

17. The MMS in accordance with claim 1, comprising a mechanical element which extends into the cavity starting from a cavity wall and is configured to restrict a deflection of the moveable element when starting from the first positioning by mechanical contact to the moveable element.

18. The MMS in accordance with claim 1, wherein the moveable element is formed to be active and for acquiring a drive signal, and configured to change, based on the drive signal, a pressure sensitivity for the fluid for a change from the first positioning to the second positioning, or vice versa; and/or to perform, based on the drive signal, a change from the first positioning to the second positioning, or vice versa.

19. The MMS in accordance with claim 1, wherein an area size of the first opening differs from an area size of the second opening; and/or
wherein an area shape of the first opening differs from an area shape of the second opening.

20. The MMS in accordance with claim 1, wherein the moveable element is suspended on both sides, wherein a suspension is asymmetrical.

21. The MMS in accordance with claim 1, wherein the moveable element comprises a sensor element configured to provide a sensor signal which is associated to a deflection state of the moveable element.

22. The MMS in accordance with claim 1, wherein the moveable element is configured to comprise, alternatingly, the first positioning, the second positioning and a third positioning, wherein the MMS is configured to let, in the third positioning, flow a higher amount of fluid through the cavity than in the second positioning.

23. A system comprising an MMS in accordance with claim 1.
